(19) United States
(12) Patent Application Publication
(10) Pub. No.: US 2014/0242098 A1
(43) Pub. Date: Aug. 28, 2014

(54) DRUG DISPENSING AND DOSING METHOD AND DEVICE

(71) Applicant: Xudong Yuan, Morganville, NJ (US)

(72) Inventor: Xudong Yuan, Morganville, NJ (US)

(73) Assignee: MONMOUTH UNIVERSITY, West Long Branch, NJ (US)

(21) Appl. No.: 14/187,638

(22) Filed: Feb. 24, 2014

Related U.S. Application Data
(60) Provisional application No. 61/768,849, filed on Feb. 25, 2013.

(51) Int. Cl. A61J 1/00; B65D 83/08

(52) U.S. Cl. CPC A61J 1/00; B65D 83/0841
USPC 424/184.1; 206/389; 242/563.2

(57) ABSTRACT

Flexible film or strip dosing device and method for various therapeutic applications are disclosed. The device includes at least one film or strip and a packaging container for the film or strip. The film or strip normally include a polymer base with or without a therapeutic agent admixed with the polymer base. The film or strip is printed with doses, marks or calibrated lines to indicate different length of the film and therefore the different doses of the therapeutic agents. The packaging container or dispenser can have marks or calibrated lines similar to a ruler which measures the length of film and therefore the different doses of therapeutic agents. The packaging container may have a built-in cutter to conveniently cut the film or strips as needed for flexible dosing of therapeutic agents.

### PRIORITY AND RELATED APPLICATION

This application claims priority to U.S. Provisional Patent Application Ser. No. 61/768,849, filed Feb. 25, 2013, entitled “FLEXIBLE FILM AND STRIP DRUG DISPENSING AND DOSING METHOD AND DEVICE,” which is hereby incorporated by reference in its entirety.

### FIELD OF THE INVENTION

The present invention relates to drug dispensing and dosing. Specifically, the present invention relates to flexible film or strip dosing device and method for various therapeutic and cosmetic applications. More particularly, a thin film or device includes at least one film or strip and a packaging container for use in providing a flexible, convenient, and effective means for delivering a wide variety of actives or medications into a consumer or patient via skin or a moistened membrane tissue structure, such as the oral or buccal mucosa, vaginal mucosa, rectal mucosa, eyes, and etc. by applying the film onto the skin or mucosa surface for efficient absorption or other purposes.

### BACKGROUND OF THE INVENTION

Most pharmaceuticals are administered in the solid dosage forms such as tablets or capsules. However, some patients, particularly pediatric and geriatric patients, have difficulty swallowing or chewing solid dosage forms. Many pediatric and geriatric patients are unwilling to take these solid preparations due to concerns of choking Therefore oral film or strip drug delivery is developed as an alternative dosage form to circumvent this problem and lead to better patient compliance.

Oral film may be a fast dissolving film or a sustained release oral film. Fast dissolving films will release the drug or actives in a short time period, mostly within few minutes, in the oral cavity. Sustained release oral films will release the drug in continuous manner in the oral cavity for a longer time. Normally, fast-dissolving film is placed on the top or the floor of the tongue or buccal area. The film is wetted by fluid in the oral cavity and retained at the site of application and rapidly releases the active agent for local and/or systemic absorption. The film delivery system can be provided in various packaging configurations, ranging from unit-dose pouches to multiple-dose blister packages or cassettes. Oral film strips are also used as a new way of freshening the breath. The films are slipped into the mouth and dissolve quickly to release antibacterial actives as well as minty flavor.

Fast dissolving film delivery system has ability to dissolve rapidly without the need for water, therefore provides an alternative to patients with swallowing disorders and to patients suffering from nausea, such as those patients receiving chemotherapy. The film delivery system can be used for local and systemic delivery. The sublingual and buccal delivery of a drug via film delivery system may provide faster onset of action, enhance the efficacy, improve the bioavailability, lower the dosing, and improve the safety profile of the medicament. Film enables improved dosing accuracy and drug stability, relative to liquid formulations since every strip is manufactured to contain a precise amount of the drug in the solid state. The small size of films also provides accurate dosing and better patient compliance. In emergency situations, film also provides dose removal possibility. Therefore the film delivery system is especially beneficial for pediatric, geriatric and neurodegenerative disease patients where proper and complete dosing can be difficult.

Currently, there are few packing options for the film delivery systems. Single pouch is one commonly used packaging. Film drug delivery pouch is a peelable pouch for “quick dissolve” soluble films with high barrier properties. The pouch is transparent for product display. Using a two structure combination allows for one side to be clear and the other to use a cost-effective foil lamination. The pouch can also be two side foil protected. The foil lamination has essentially zero transmission of both gas and moisture. The package provides a flexible thin film alternative for pharmaceutical and nutraceutical applications. The single dose pouch provides both product and dosage protection.

The other option for film packaging is a blister card with multiple strips. The blister container consists of two components: the blister, which is the formed cavity that holds the product, and the lid stock, which is the material that seals to the blister. The film selection should be based upon the degree of protection required. Generally the lid stock is made of aluminum foil. The material used to form the cavity is typically a plastic, which can be designed to protect the dosage form from moisture.

However, the current film format only offers one dose at a fixed amount of drug or actives. The current film format cannot offer different amount of dose, which is usually required for different conditions and different ages of patients, such as children, adults, and seniors. Therefore, there is a great need to offer flexible dosing by film delivery system.

### BRIEF SUMMARY OF THE INVENTION

A medication strip and medication strip dispensing unit are disclosed to allow users to dispense flexible doses of medicated film strips. A length of the film strip will have a specific amount of medication and will be dispensed by length or marks. The film strip may be marked or unmarked with dosage amounts. Likewise the dispensing unit or device may be marked for use with unmarked film strips or unmarked for use with marked film strips. The dispensing unit or device may be manual or automated and have any size, shape and be manufactured using any materials.

### BRIEF DESCRIPTION OF THE DRAWING

FIG. 1 is a marked film strip of the present invention. Markings shown are exemplary and do not limit the invention.

FIG. 2A is a marked film strip dispensing container or device indicating different doses, which are provided for illustrative purposes. The marked container may be used to dispense unmarked film strips.

FIG. 2B is an unmarked film strip dispensing container or device used to dispense marked film strip such as that shown in FIG. 1.

FIG. 3A is an automatic film or strip dispensing container or device.

FIG. 3B is sectional view of the device in FIG. 3A shown along section lines 3B-3B.

### DETAILED DESCRIPTION OF THE INVENTION

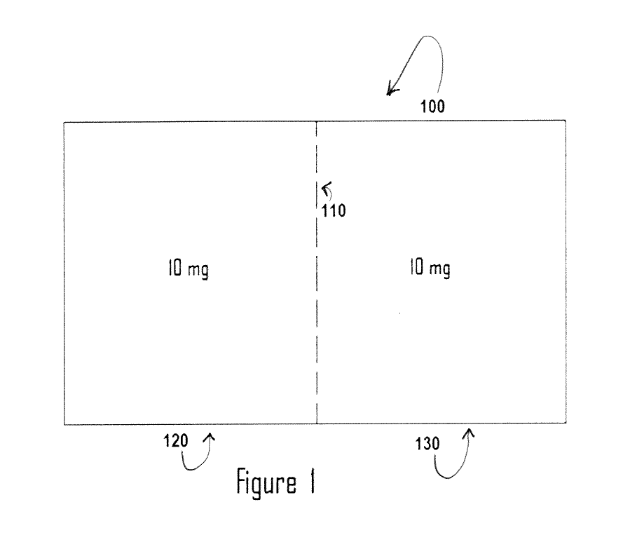

FIG. 1 shows a film or strip 100 in solid dosage form having marker 110 comprising either printed lines or etched markings. Marker 110 are calibrated lines on the strip 100 to indicate different length of the film and different doses of the therapeutic agents. Markers 100 may be employed by but not limited to printing, painting, drawing, tapping, labeling, punching or other marking methods to indicate the required doses. The dose may also be indicated on the film or strip by above-mentioned methods. Any substance used to make marker 100 is nontoxic and not active, and will not interfere with drug properties in the strip.

FIG. 1 shows strip 100 having two 10 mg dose films, 120, 130, that can be easily obtained by cutting along the line. The strip shown in FIG. 1 is provided for illustration and other strip lengths, dosage amounts, number of dose strips 120, 130 and marker 110 may be employed with the present invention. The strip is shown in a rectangular shape but is not limited in shape and may have different geometric shapes.

The film or strip delivery systems of the present invention include a variety of film delivery systems, including but not limited to, fast dissolving film delivery system, sustained release or slow release film delivery system, delayed release film delivery system, pulsatile release film delivery system, and other controlled release film delivery systems.

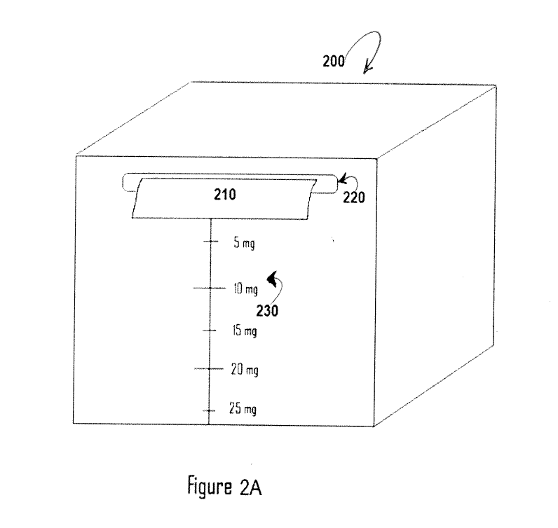

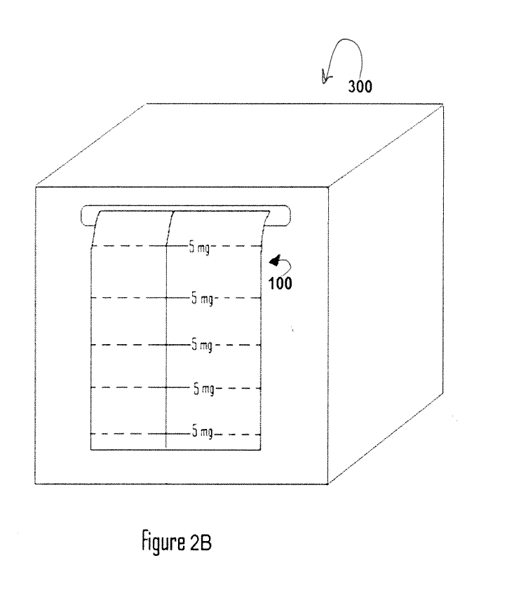

Referring now to FIG. 2A, an unmarked film strip 210 is shown in a packaging container 200 having markers 230, being marks or calibrated lines similar to a ruler. The markers 230 are disposed on the exterior surface of the container 200 below an opening 220 through with the strip 210 exits. The markers 230 shown on container 200 include 5 mg, 10 mg, 15 mg, 20 mg, 25 mg, and etc. Such markings are exemplary and can be varied based on the dosage of the strip 210 used. The markers 230 may be printed or etched on to the exterior of the container or may be affixed to the exterior of the container such as via a sticker or label.

The container 200 is used to cut the strip 210 at the desired length by measuring a length of the strip 210 along the marker 230 to dispense a desired dosage of therapeutic agents in the strip 210. The container may have a built-in cutter, not shown, to conveniently cut the strip 210 as needed for certain doses of therapeutic agents. If a marked strip 100 is used, an alternative embodiment of the container 300 is employed as shown in FIG. 2B. Here the different doses are marked directly on the strip 100. The doses of the strip 100 are dispensed according to the lines or marks on the film. Here too a built-in cutter may be used to conveniently cut the film. The container 200, 300 may be produced in any shape and need not be limited to the square shape as illustrated in the figures. The containers 200, 300 will have varied shapes and be either marked on the exterior or unmarked and also optionally employ a cutter. The containers will be made of any suitable material including but not limited to plastic or metal.

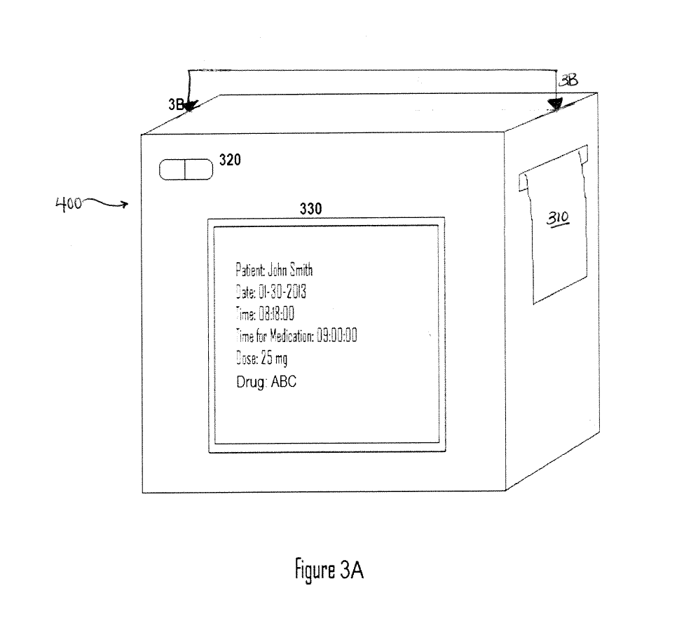

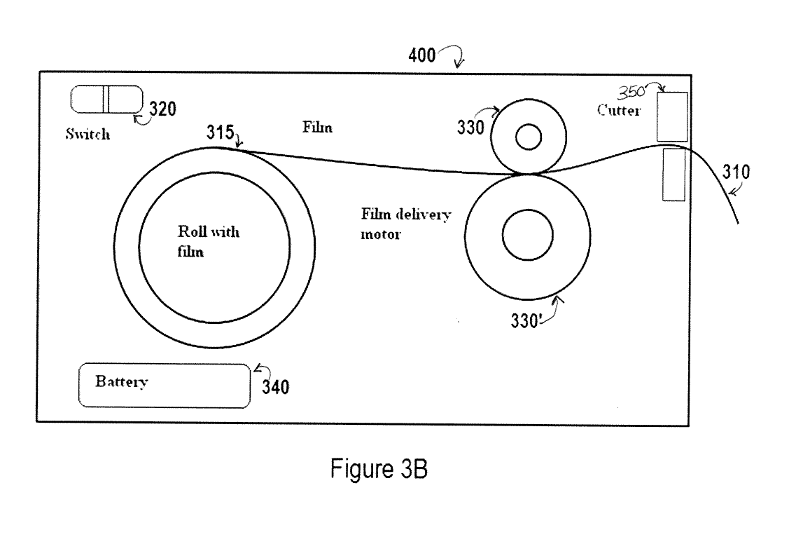

In another embodiment, the packaging container may be an automatic drug tape dispensing and metering device 400. See FIG. 3. The device 400 contains a film roll 315 housed in a small reusable portable dispenser unit 400. See FIG. 3B. The automatic dispenser 400 retains a film roll 315 to dispense a predetermined length and dose of the strip 310. The dispenser 400 further includes a display 330, a switch 320 to activate the dispenser. Inside the dispenser 400 is the film roll 315, a motor and cams 330, 330′, a cutter 350 and a power source 340.

In one embodiment, measurement device in the dispenser 400 used to measure the length of the film being dispensed may be the cam and motor. For instance, the film roll 315 is driven by a motor and cams 330, 330′ inside the dispenser to deliver a strip 310 outside the dispenser 400. The built-in cutter 350 can cut the film strip 310 according to the desired dose. Initially, the dose will be calibrated according to the film or strip 310 length. The length of the strip 310 can be measured by the turns and perimeter of the cams delivering the film. The length of the film or strip 310 can be converted to different dose of the drug. For example, if one centimeter of film equals 10 mg of the drug then two centimeters of the strip 310 would equal 20 mg of the drug.

The built-in cutter conveniently cuts the film to provide certain doses as needed. By employing the cutter, different doses, such as 5 mg, 10 mg, 15 mg, and etc. can be dispensed automatically (5 mg, 10 mg, 15 mg, 25 mg are for illustration purpose, any other dose can be used.) In another embodiment the film 310 can be pre-marked with dose of drug (for example, 1 mg, 5 mg, 10 mg and etc.) The automatic dispenser 400 can dispense the strip 310, which will be then cut as needed to the required dose for a patient. Calibration and calculations are needed for different types of film strips with different drugs. The calibration information can be entered in setting in the automatic dosage dispenser 400. Marks or scales of different doses can also be printed outside of the automatic dosage dispenser with or without a built-in cutter.

The film or strip normally include a polymer base with or without a therapeutic agent admixed with the polymer base. Therapeutic agents may be selected from, but not limited to, the group consisting of an analgesic, a non-steroidal anti-inflammatory agent, a steroid, a hormone, an antihistamine, a tranquilizer, an antidepressant, a hypnotic, a sedative, cold and flu medicines, an antiepileptic, an awakening agent, a psychoneurotropic agent, a neuromuscular blocking agent, an antispasmodic agent, an antihistaminic, an antiallergic, a cardiotonic, an antiarhythmic, a diuretic, a hypotensive, a vasopressor, an antitussive expectorant, a thyroid hormone, a sexual hormone, an antidiabetic, an antitumor agent, an antibiotic, a chemotherapeutic, a narcotic, a vaccine, Lactobacillus acidophilus, Lactobacillus casei, Lactobacillus paracasei, Lactobacillus pediocci, Bifidobacterium bifidus, Bifidobacterium longum, Enterococcus faecium, and Saccharomyces boulardii and other beneficial genera and species of probiotics, and mixtures thereof.

Also, the active substance in the film delivery system may be from any class of pharmaceutically active substances that can be administered orally or through the buccal mucosa, vaginal mucosa, rectal mucosa, eyes, etc. by applying the film onto the skin or mucosa surface. Classes of pharmaceutically active substances that come into consideration are, for example but not limited to, nicotine and salts and derivatives thereof, e.g. nicotine tartrate or nicotine polacrilex; hormones, e.g. melatonin; fluoride supplements, e.g. sodium fluoride or others fluoride salts; local disinfectants, e.g. benzoxonium chloride, chlorhexidine or benzalkonium chloride; local anaesthetic agents; cold and flu medicines, and etc. Preferred pharmaceutically active agents includes chlorpheniramine maleate, brompheniramine maleate, dexchlorpheniramine, triprolidine hydrochloride, acrivastine, azatadine maleate, loratidine, phenylephrine hydrochloride, dextromethorphan hydrochloride, ketoprofen, sumatriptan succinate, zolmitriptan, loperamide, famotidine, nicotine, caffeine, diphenhydramine hydrochloride, and pseudoephedrine hydrochloride, and their amounts per strip are well known in the art.

The film delivery system requires the use of polymers to form the film and as the support to actives. The polymer may be water soluble, water insoluble, or a combination of one or more either water soluble or water insoluble polymers. The polymer may be selected from the group consisting of a starch-based polymer, a lipid-based polymer, a glycerin-based polymer, protein-based polymer and mixtures thereof. The polymer may include cellulose or a cellulose derivative. The water soluble polymers include, but are not limited to, pullulan, hydroxypropylmethyl cellulose, hydroxyethyl cellulose, hydroxypropyl cellulose, polyvinyl pyrrolidone, carboxymethyl cellulose, polyvinyl alcohol, sodium aginate, polyethylene glycol, xanthan gum, tragancanth gum, guar gum, acacia gum, arabic gum, polyacrylic acid, methylmethacrylate copolymer, carboxyvinyl copolymers, carboxyvinyl polymer, amylose, high amylose, starch, hydroxypropylated high amylose starch, dextrin, pectin, chitin, chitosan, levan, elsinan, collagen, gelatin, zein, gluten, soy protein isolate, whey protein isolate, casein and mixtures and combinations thereof.

In order to form a durable film, plasticizers are commonly used in the film to improve flexibility of film. Plasticizers include glycerin, sorbitol, propylene glycol, polyethylene glycol, triacetin, triethyl citrate (TEC), acetyl triethyl citrate (ATEC) and other citrate esters and mixtures thereof. The film may also be mixed with solvents such as alcohols, various PEGs and mixtures thereof. Also one or more surfactants may be admixed with the polymer strip, wherein said surfactant is one of polysorbates, Tweens, any other surfactants and mixtures thereof.

Flavoring agents are used to impart the film with certain flavor. Flavoring agents includes but not limited to the essential oils or water soluble extracts of menthol, wintergreen, peppermint, sweet mint, spearmint, vanillin, cherry, chocolate, cinnamon, clove, lemon, orange etc.

Sweetening agent is commonly used to improve the taste or mask the bitter taste of certain drugs in the film. Sweeteners include sugar, dextrose, lactose, mannitol, sucrose, xylitol, malitol, acesulfame potassium, neotame, talin, glycyrrhizin, sucralose, aspartame, saccharin acesulfame K, fructose, glucose, maltose, maltooligosaccharides, invert sugars, isomaltooligosaccharides, saccharified starch, isomerized sugars, and mixtures thereof.

Coloring agents may include FD & C coloring agents, natural coloring agents, and natural juice concentrates, pigments such as titanium oxide, silicon dioxide and zinc oxide. Coloring agents may further be selected from, but not limited to, the group consisting of FD&C Blue No. 1, FD&C Blue No. 2, FD&C Green No. 1, FD&C Green No. 2, FD&C Green No. 3, FD&C Orange No. 1, FD&C Red No. 1, FD&C Red No. 2, FD&C Red No. 3, FD&C Red No. 4, FD&C Red No. 32, FD&C Red No. 40, FD&C Yellow No. 1, FD&C Yellow No. 3, FD&C Yellow No. 4, FD&C Yellow No. 5, FD&C Yellow No. 6, and mixtures thereof.

The present invention discloses several methods for flexible and multiple dosing using film delivery systems. The present invention overcomes the shortcomings of the prior art by providing a novel and nonobvious thin film device, kit, method of using the same.

The present invention provides improved methods of delivering a wide variety of actives or medications into a consumer or patient via skin or a moistened membrane tissue structure, such as the oral or buccal mucosa, vaginal mucosa, rectal mucosa, eyes, and etc., by applying the film onto the skin or mucosa surface for efficient absorption or other purposes.

Numerous objects, features and advantages of the present invention will be readily apparent to those of ordinary skill in the art by reading the detailed description when taken in conjunction with the accompany drawings. The invention is not limited in its application to the details of construction and to the arrangements of the components set forth above via the description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A medicated film strip wherein the strip includes markers to indicate doses of medication provided in a length of said film strip.

2. The film strip of claim 1, wherein the markers are etched in said film strip.

3. The film strip of claim 1, wherein the markers are printed on said film strip.

4. The film strip of claim 1, wherein the doses are printed on said film strip.

5. A film strip dosage system comprising:
a film roll comprised of film strips of medication;
a housing retaining said film strip; and
a film strip opening disposed on the housing, said opening dimensioned and configured to receive and dispense said film strip.

6. The system of claim 5 wherein the film strip is marked, said marked film strip defining dosed amounts of medication within said film strip.

7. The system of claim 5 wherein the dose amount is printed on the film, said printed dose defining dosed amounts of medication within said film strip.

8. The system of claim 5 wherein the housing is marked with measurement marks of increasing order, wherein the film strip is measured to one said measurement mark to define a dosed amount of medication within said film strip.

9. The system of claim 5 wherein the housing has a cutter to cut the film strip.

10. An automated film strip dosage system comprising:
a film roll comprised of film strips of medication;
a housing retaining said film strip;
a cam and motor connected to said film roll and dispensing a single film strip of medication, wherein a perimeter of the cam defines a specific measurement of the strip that equates to a dosage amount of medication within the medicated film strip; and
a film strip opening disposed on the housing, said opening dimensioned and configured to receive and dispense said film strip, wherein the system dispense a predetermined length and dose of the film strip.

11. The system of claim 10, wherein a dose of said film strip is measured by turns and of the cam delivering the film strip.

12. The system of claim 10 wherein the film strip is marked, said marked film strip defining dosed amounts of medication within said film strip.

13. The system of claim 10 wherein the housing is marked with measurement marks of increasing order, wherein the film strip is measured to one said measurement mark to define a dosed amount of medication within said film strip.
